(19) United States
(12) Patent Application Publication
(10) Pub. No.: US 2004/0225730 A1
(43) Pub. Date: Nov. 11, 2004

(54) Content manager integration

(76) Inventors: Albert C. Brown, Huntington Beach, CA (US); Philippe M. Burlina, Irvine, CA (US); Stephane Depuy, Irvine, CA (US); Steven C. Dickson, Newport Beach, CA (US); Leslie Ekas, Seattle, WA (US); Lauren Mayes, Laguna Beach, CA (US); Haibing Qiao, Irvine, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/758,953

(22) Filed: Jan. 16, 2004

Related U.S. Application Data
(60) Provisional application No. 60/441,429, filed on Jan. 17, 2003.

(51) Int. Cl. G06F 15/173

(52) U.S. Cl. 709/224

(57) ABSTRACT

A system for managing electronic content on a computer network comprises an electronic content library. The electronic content library is configured to store a plurality of files, and to maintain revision history data for the files stored therein. The system further comprises a web content manager configured to publish one or more of the files stored in the electronic content library on a webpage. The system further comprises a content manager. The content manager is configured to check-out a selected file from the electronic content library upon a user's request, and to check-in an updated version of the selected file to the electronic content library. Checking-in the updated version of the selected file causes the revision history data in the electronic content library to be updated. The system further comprises an event trigger subsystem configured to notify the web content manager of the updated version of the selected file based on the revision history data.

### PRIORITY APPLICATION

This application claims the benefit of U.S. Provisional Application No. 60/441,429, filed 17 Jan. 2003. This application is being filed concurrently with related U.S. Patent Application [Attorney Docket FILNTP.394A], entitled “System and Method of Managing Web Content”. The foregoing provisional application and related application are hereby incorporated by reference in their entirety.

### FIELD OF THE INVENTION

The present invention relates generally to a system for managing content stored on a computer network, including content that is to be published on the Internet.

### BACKGROUND OF THE INVENTION

A “web content manager” (“WCM”) is a system that is configured to manage information available on a website. Websites often contain large numbers of webpages, each of which can contain a wide variety of electronic content, such as text, images and sounds. A conventional WCM assists website administrators with the tasks associated with the development, deployment and management of a website and of the electronic content available thereon.

While conventional WCM are powerful tools for website administration, certain deficiencies exist in these systems. For example, conventional WCM are not well configured for managing content revision history and workflow processes. Features such as these are particularly important when several users collaborate to generate and revise web content on large websites, which may comprise thousands of different webpages. In particular, a website administrator using a conventional WCM may have a difficult time ensuring that the electronic content contained in the webpages is current may have a difficult time managing the content review and approval process, and may have a difficult time ensuring that when one webpage is modified, other webpages affected by that change are updated appropriately.

A variety of “document management systems”, or more generally, “enterprise content management systems” (“ECMS”), have been developed to help computer users manage features such as content searching, content revision history and workflow processes. ECMS are often implemented on a wide-scale basis, such as on an organization-wide basis, thereby helping users to work together with the files stored in an ECMS content library. However, conventional ECMS systems are generally independent from WCM systems, and thus the ECMS functionality is not available to web content managed by the WCM.

### SUMMARY OF THE INVENTION

In accordance with the foregoing, a system has been developed to integrate the content management functionality of an ECMS with the web content management functionality of a WCM. This integrated system allows web content to be managed inside the ECMS, thereby enabling ECMS functionality on the web content, including enhanced search capability, access control, revision history management and workflow management. For example, the integrated system optionally includes an event feedback mechanism for automatically updating a website using the WCM when web content stored in the ECMS is revised.

In one embodiment of the present invention, a system for managing electronic content on a computer network comprises an electronic content library. The electronic content library is configured to store a plurality of files, and to maintain revision history data for the files stored therein. The system further comprises a web content manager configured to publish one or more of the files stored in the electronic content library to a website. The system further comprises a content manager. The content manager is configured to check-out a selected file from the electronic content library upon a user's request, and to check-in an updated version of the selected file to the electronic content library. Checking-in the updated version of the selected file causes the revision history data in the electronic content library to be updated. The system further comprises an event trigger subsystem configured to notify the web content manager of the updated version of the selected file based on a modification to the selected file.

In another embodiment of the present invention, a computerized system for managing electronic content comprises an electronic content library. The electronic content library is configured to store web-based and non-web-based related electronic content. The system further comprises a web content manager configured to perform a web-based related activity. The system further comprises an event trigger subsystem configured to invoke an event in response a change to the web-based related electronic content stored in the electronic content library. The event triggers the web content manager to perform the web-based related activity.

In another embodiment of the present invention, a computerized system for managing electronic content comprises an electronic content library. The electronic content library is configured to store published and non-published electronic content. The system further comprises a first content processor for managing the published and non-published electronic content. The system further comprises a second content processor for managing the publication of the published electronic content. The system further comprises an event trigger subsystem in the first content processor configured to invoke an event in response a change to the published electronic content stored in the electronic content library. The event triggers a process in the second content processor for performing at least one publication related activity.

In another embodiment of the present invention, a computerized system for managing electronic content comprises a content manager configured to store electronic content. The system further comprises a web content manager configured to perform a workflow process on electronic content, wherein the workflow process is a web-based related activity. The system further comprises an event trigger subsystem configured to invoke the workflow process in response to a modification of the electronic content stored in the content manager.

In another embodiment of the present invention, a system for managing electronic content comprises a first means for storing electronic content. The system further comprises a second means for invoking a web-based related workflow process in response to a modification of the electronic content stored in the content manager.

In another embodiment of the present invention, a method for managing electronic content on a computer network comprises storing a plurality of files in an electronic content library. The method further comprises maintaining revision history data for at least one of the files stored in the electronic content library. The method further comprises publishing one or more of the files stored in the electronic content library using a web content manager. The method further comprises checking-out a selected file from the electronic content library upon a user's request. The method further comprises checking-in an updated version of the selected file to the electronic content library. The method further comprises updating the revision history data in the electronic content library in response to the updated version of the selected file being checked-in. The method further comprises notifying the web content manager of the updated version of the selected file based on a modification to the selected file.

In another embodiment of the present invention, a method for managing electronic content comprises storing web-based and non-web-based related electronic content in an electronic content library. The method further comprises invoking an event in response to a change to the web-based related electronic content stored in the electronic content library. The event triggers a web content manager to perform at least one web-based related activity.

In another embodiment of the present invention, a method for managing electronic content comprises storing published and non-published electronic content in an electronic content library. The method further comprises managing the published and non-published electronic content in a first content processor. The method further comprises managing the publication of the published electronic content in a second content processor. The method further comprises invoking an event in response to a change to the published electronic content stored in the electronic content library. The event triggers a process in the second content processor for performing at least one publication related activity.

For purposes of summarizing the invention, certain aspects, advantages, novel features, and exemplary embodiments of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

The drawings describe a general architecture that implements certain embodiments of the invention. The drawings, and their associated descriptions, are provided to illustrate exemplary embodiments of the invention, and not to limit the scope of the invention. Throughout the drawings, reference numbers are used to indicate correspondence between referenced elements. It will be appreciated that the illustrated boundaries of elements (for example, boxes, groups of boxes, or other shapes) in the figures represent but exemplary boundaries. An ordinarily-skilled artisan will appreciate, for example, that one element may be designed as multiple elements or that multiple elements may be designed as one element. An element shown as an internal component of another element may also be implemented as an external component, and vice-versa.

FIG. 1A is a schematic illustration of selected components of an exemplary enterprise content management system that has been integrated with a web content manager.

FIG. 1B is a process flow diagram illustrating an exemplary procedure for updating web content using the integrated system of FIG. 1A.

FIG. 2A is a flowchart illustrating an exemplary procedure for revising content stored in an enterprise content management system.

FIG. 2B is a flowchart illustrating an exemplary procedure for updating web content using an enterprise content management system that has been integrated with a web content manager.

FIG. 2C is a flowchart illustrating an exemplary procedure for controlling access to web content stored in an enterprise content management system.

FIG. 3 is a flowchart illustrating an exemplary procedure for performing a website integrity review when web content stored in an enterprise content management system is revised.

FIG. 4 is a process flow diagram illustrating an exemplary content approval workflow that can be used in the procedure of FIG. 3.

FIG. 5 is a flowchart illustrating an exemplary dependent update workflow procedure that can be used in the procedure of FIG. 3.

### DETAILED DESCRIPTION OF PREFERRED EMBODIMENTS

As described above, a system has been developed that integrates ECMS functionality, such as enhanced search capabilities, access control, revision history management and workflow management, with the website management functionality of a WCM. This integrated system can be used to facilitate management of a website, such as a public website that is connected to the global computer network commonly referred to as the “Internet,” or a private website that is connected to a limited number of users, such as an intranet.

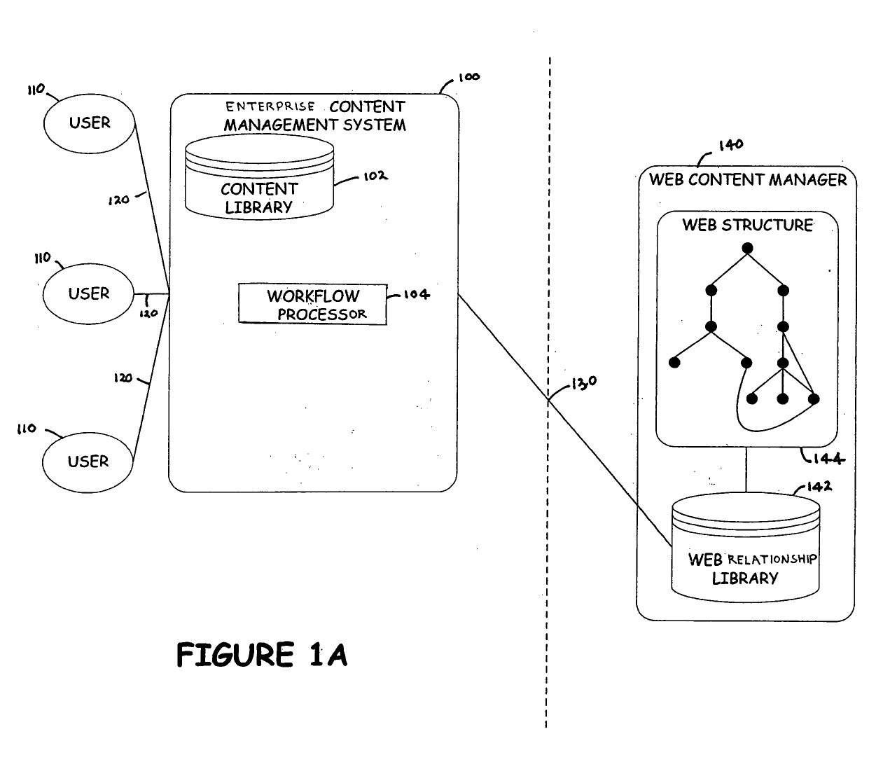

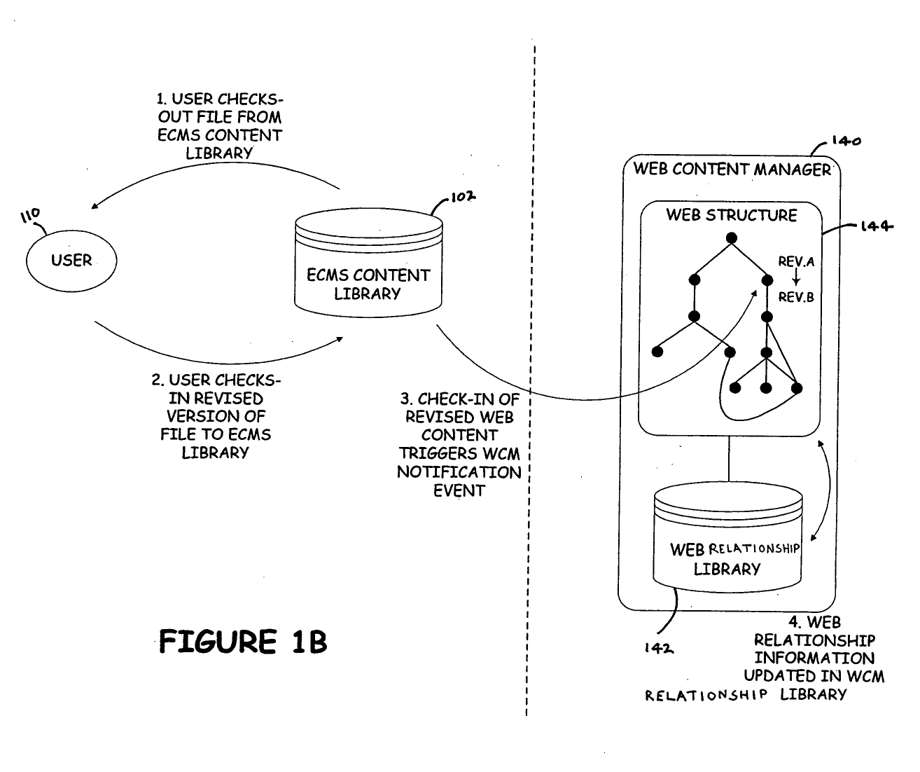

Selected components of an exemplary integrated ECMS/WCM system, also referred to herein as an “integrated system,” are illustrated in FIG. 1A. In the illustrated exemplary embodiment, the integrated system comprises an ECMS 100 that is accessible to one or more user computers 110 via a communication medium 120. Other components can be included in other embodiments.

The communication medium 120 is any communication system configured to allow the user computers 110 to communicate with the ECMS 100. As used herein, the term “communication medium” refers, in addition to its ordinary meaning, generally to dedicated communication lines, telephone networks, wireless data transmission systems, two-way cable systems, customized computer networks, interactive kiosk networks, automated teller machine networks, interactive television networks, coaxial cables, copper wire, fiber optics cables, or the like. The communication medium can also take the form of acoustic or light waves, such as those generated during radio-wave and infrared data communications, a carrier wave/pulse, or any other medium from which a computer, a processor or other electronic device can communicate therewith. In one embodiment, the communication medium is the Internet.

The user computers 110 are devices that allow a user to interact with the ECMS 100 via the communication medium 120. For example, in one embodiment, the user computer is a conventional computer that is equipped with a conventional modem. As used herein, the term “computer” refers, in addition to its ordinary meaning, generally to devices that comprise processors, program logic, or other substrate configurations representing data and instructions, which operate as described herein. In other embodiment, the computers can comprise controller circuitry, processor circuitry, processors, general purpose single-chip or multi-chip microprocessors, digital signal processors, embedded microprocessors, microcontrollers, integrated circuits, application specific integrated circuits (ASIC), discrete logic, or the like. In yet other embodiments, the computers can include hardware, firmware, software and/or other combinations of these to perform a function or an action, and/or to cause a function or action.

In other embodiments, the user computer is a device that allows the user to interact with the ECMS 100, such as a computer workstation, a local area network of individual computers, a kiosk, a point-of-sale device, a personal digital assistant, an interactive wireless communications device, an interactive television, a transponder, or the like. Furthermore, the user computer can include, but is not limited to, hardware, software, or other devices, or combinations of these.

Still referring to FIG. 1A, in an exemplary embodiment the ECMS 100 comprises a general content repository that stores a variety of electronic content. As used herein, the term “content” refers, in addition to its ordinary meaning, generally to information stored in an electronic form that can be managed by one or more of a content management system, a document management system, a business process management system, or the like. Examples of such content includes binary data, structured data (such as data stored in databases), unstructured data (such as image documents), folders, word processing documents, CAD/CAM documents, source code files, object code files, physical documents, physical objects, and the like. Generally, content management systems are also able to manage physical documents and objects not residing within the system by storing and managing metadata about the physical documents and objects. As used herein, “metadata” refers, in addition to its ordinary meaning, generally to definitional data that provides information about other data managed within the ECMS content library 102.

The exemplary ECMS 100 illustrated in FIG. 1A includes a content library 102 and a workflow processor 104. The ECMS 100 can also include other libraries in other embodiments. Although the content library is illustrated as an individual block element in FIG. 1A, it generally comprises data storage systems that comprise a computer-readable medium. The data storage systems can be unitary or distinct, and that can use a variety of data storage schemes. For example, the content libraries comprising the ECMS 100 can include a cluster of databases using data mirroring or replication to enhance data security and availability.

As used herein, the term “computer-readable medium” refers, in addition to its ordinary meaning, generally to a medium that participates directly or indirectly in providing signals, instructions and/or data to one or more processors for execution. Such a medium can take many forms, including but not limited to, nonvolatile media, volatile media, and transmission media. Nonvolatile media includes, for example, optical or magnetic disks. Volatile media includes, for example, dynamic memory. Transmission media includes, for example, coaxial cables, copper wire, and fiber optic cables. Transmission media can also take the form of acoustic or light waves, such as those generated during radio-wave and infrared data communications, or can take the from of one or more groups of signals. Common forms of computer-readable media include, for example, floppy discs, flexible discs, hard discs, magnetic tape, other magnetic media, CD-ROMs, other optical media, punch cards, paper tape, other physical media, RAM, PROM, EPROM, Flash-EPROM, other memory chips or cartridges, carrier waves/pulses, or other medium from which a computer, processor or other electronic device can interface.

The content library 102 generally includes content provided by users of the integrated system, including content that is published, or that is to be published, on a website, including rendered web content. Rendered web content comprises content assembled into its final form for inclusion as one or more webpages in a website. As used herein, the term “webpage” refers, in addition to its ordinary meaning, generally to a tangible representation of the rendered web content, or that which a website viewer perceives. Many forms of content can contribute to the generation and display of a webpage. Webpages can be generated in whole or in part using one or more of the following forms of content: HTML, XML, Java, Javascript, CGI files, GIF files, JPEG files, MPEG files, WAV files, WAV files, and text files. Webpages can be generated using other forms of content as well. The term “rendered web content” generally refers to the foregoing formats of content, and other content, regardless of format, that helps define a webpage. In one embodiment, the rendered web content stored in the content library 102 has been rendered into a form that, if deployed to a web server, would be accessible to a web browser without further modification.

The content library can also be configured to include published content that is not web based. For example, in one embodiment, content is published via file sharing arrangements on a computer network. In another embodiment, content is published using distribution lists implemented with an electronic mail system. In other embodiment, still other non-web based publication techniques can be used to publish content stored in the ECMS content library 102.

Still referring to FIG. 1A, the ECMS stores a workflow process definition in the content library 102. The workflow process definition defines a process that the workflow processor 104 is configured to execute. As used herein, the term “workflow process” refers, in addition to its ordinary meaning, generally to one or more ordered steps or operations to be performed by one or more participants on associated content. The participants can be humans or automated processes. For example, in an exemplary workflow process, one or more reviewers, such as a web site development supervisor and a product sales supervisor, review additions, modifications, or deletions to content before the content is deployed to an accessible web server.

According to an exemplary workflow process, each reviewer can approve the content for publication, edit the content prior to approving the content for publication, reject the content or the like. Advantageously, each workflow process can define what happens if each option is taken. For example, a workflow process can specify that when a reviewer rejects a proposed modification of content, the person that originally proposed the modification has a chance to edit the modification. As another example, a workflow process can specify that rejections result in erasing any modification, without any further input. In one embodiment, the workflow process content is encoded using XML. Advantageously, a graphical or other workflow process design tool can be provided to allow users without programming experience to design workflow processes. Additionally, preset workflow processes that do not require design, or that require only minimal modifications, can be provided with the system.

The content library includes user authentication content relating user classes with actions that can be performed on the content stored in the content library 102. In an exemplary embodiment, users of the integrated system belong to one or more classes that define which actions, if any, the users are authorized to perform on the content stored in the content library 102. For example, in one embodiment, a user belonging to the class “reviewer” is authorized to view but not edit content stored in the content library 102. Other user classes, and more complex authorization configurations, can be defined in other embodiments.

Still referring to the exemplary embodiment illustrated in FIG. 1A, the ECMS is linked to a WCM 140 via a communication medium 130. The WCM 140 is configured to allow web developers, which can include humans and/or automated processes, to define web content relationship information that comprises a website. For example, in an exemplary embodiment, the WCM 140 comprises computer-executable code configured to perform website development functions. The computer-executable code can be developed using a wide variety of computer languages, development tools, or the like. Additionally, the computer-executable code can be compiled into object code capable of running on a wide variety of computers known now, or developed in the future. Optionally, the computer-executable code can be interpreted rather than compiled, or can be compiled into a code that is subsequently interpreted. The functions described herein may also be performed wholly or partially in hardware or in firmware.

In the exemplary embodiment illustrated in FIG. 1A, the WCM 140 includes a web relationship library 142 capable of storing web content relationship information, such as a web structure 144. Under this configuration, the content that defines the building blocks of a website, referred to herein as “web content,” is stored within the content library 102 of the ECMS 100. In contrast, the web content relationship information, which relates the content into an ordered structure, is generated by the WCM 140 and is stored in the web relationship library 142. Using this system, the WCM is capable of generating and publishing a dynamic website structure using the web content stored in the ECMS content library 102 and the WCM-generated web content relationship information stored in the web relationship library 142. In a modified embodiment, web content relationship information can also be stored in the ECMS content library 102.

This web development architecture advantageously facilitates content reuse. For example, developers and/or automated processes can quickly refer to content by a reference to the appropriate version of the content in the ECMS content library 102, thereby facilitating efficient and consistent website development. For example, content reuse facilitates development of websites having a consistent look and feel, such as website that consistently present an organizational logo and other identifying information, along with a consistent menu bar or other website navigational system. Additionally, content reuse also allows website developers to create content once, regardless of how often that content appears in a website.

When users 110 modify web content stored in the ECMS content library 102, these modifications should be propagated to the WCM 140 if the modifications are to be reflected in the corresponding published webpage. FIG. 1B illustrates an exemplary process for propagating updated web content to a WCM using the integrated system of FIG. 1A. As illustrated, when a user 110 checks-in modified web content, such as a computer file, to the ECMS library 102, the web content check-in process can be configured to invoke a workflow procedure that notifies the WCM 140 of the modified web content. The web content check-in process can be configured to invoke other workflows in other embodiments, as will be described in greater detail below.

Referring still to FIG. 1B, when the WCM 140 is notified that modified web content exists in the ECMS content library 102, additional workflows can be invoked. In an exemplary embodiment, a workflow that updates the web content relationship information in the web relationship library 142 is invoked when modified web content is detected. For example, as illustrated in FIG. 1B, if a particular web content component is revised from Revision A to Revision B in the ECMS content library 102, then references to the revised content in the WCM 140 are updated.

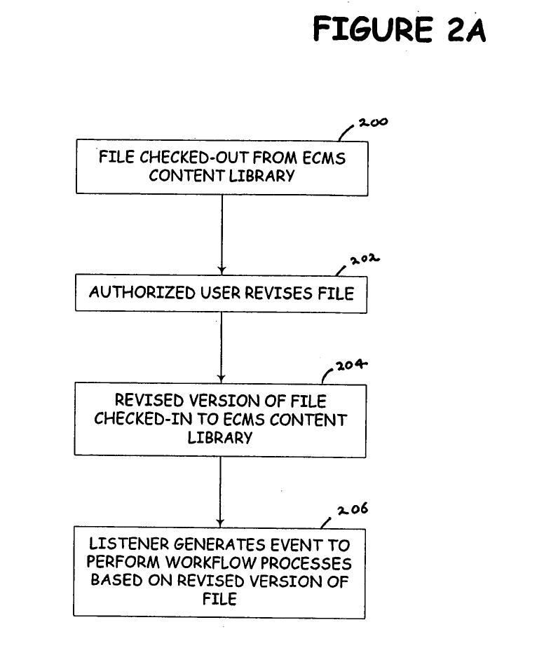

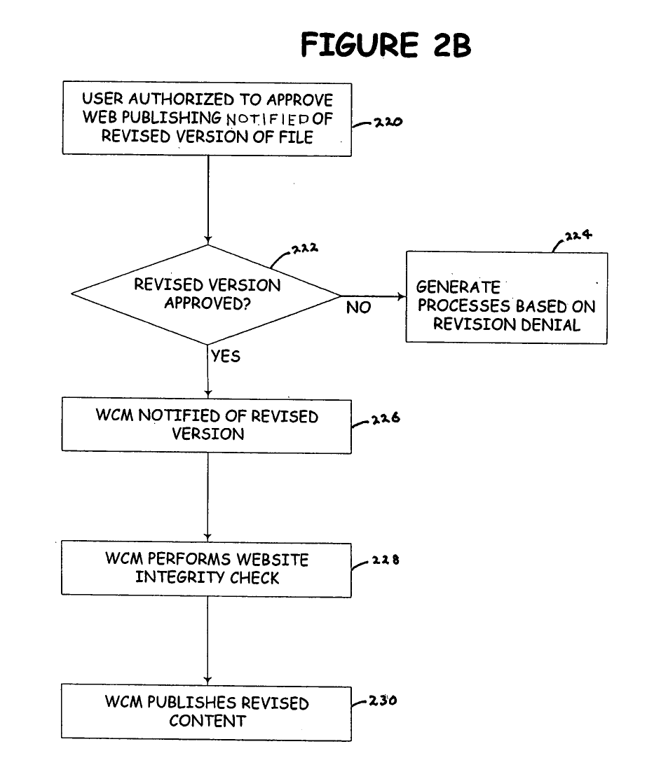

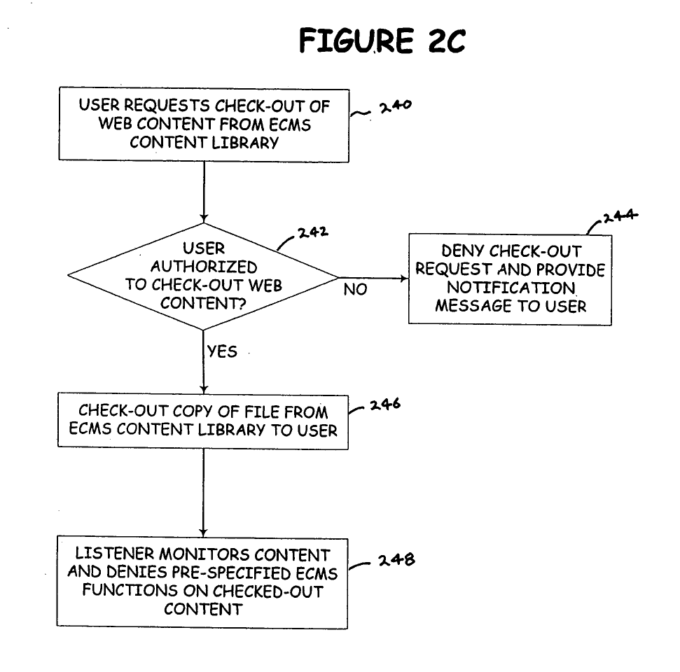

The procedures described with respect to FIG. 1B can be revised in a variety of ways to accommodate various workflows to be performed with the web content. For example, FIG. 2A is a flowchart illustrating an exemplary process for invoking a workflow based on modifications made to web content stored in the ECMS content library 102. As illustrated in FIG. 2A, an authorized user checks out web content, such as a computer file, from the ECMS content library 102 in an operational block 200. The authorized user revises the web content in an operational block 202, using one or more of a variety of different software applications that can be used to modify web content. Examples of such software include word processors, HTML editors, desktop publishers, and digital multimedia studios.

Still referring to FIG. 2A, the user then checks-in the revised web content to the ECMS content library 102 in an operational block 204. The ECMS 100 is optionally configured to track revision history of the web content as part of the ECMS check-in procedure. An event trigger subsystem, which includes a listener that is configured to monitor the ECMS content library 102 for check-in of web content to the ECMS content library 102, detects the web content check-in and launches one or more workflow processes in response to the checked-in web content in an operational block 206.

The event trigger subsystem provides a mechanism for notifying the WCM of modifications to web content stored in the ECMS content library 102. The event trigger subsystem can be triggered using a variety of techniques. For example, in one configuration, the web content in the ECMS content library 102 is stored in web folders which are monitored by the event trigger subsystem. In this configuration, when content is accessed, such as for a check-out or a check-in procedure, the event trigger subsystem is activated, and one or more appropriate workflow procedures, including for example WCM notification, modification approval, and/or deployment, can be invoked.

In other configurations, the event trigger subsystem can be triggered using other techniques. For example, the event trigger subsystem can be configured to monitor various user actions on specified web content, such that when a specified user action is made, the event trigger subsystem is activated, and an appropriate workflow procedure can be invoked. This configuration can be made to trigger workflow when content is revised, and also when content is “rolled back” to a previous version. The event trigger subsystem can be configured to be activated when a wide variety of other events occur, such as when a new folder is created in the ECMS content library 102, when content is checked-out of the ECMS content library 102, or when content is deleted from the ECMS content library. As described above, when the event trigger subsystem is activated, an appropriate workflow procedure can be invoked. An exemplary workflow procedure comprises WCM notification, thereby enabling the WCM to perform a variety of different activities, such as web-based related activities. Examples of web-based related activities include, but are not limited to, launching an approval workflow for new major versions, launching an approval workflow for new content, launching a deployment workflow for new approved content, denying content checkout for content not controlled by the WCM, and denying unauthorized users access to specified content.

In another embodiment the listener is configured to launch a “content approval” workflow process when revised web content is checked-in to the ECMS content library 102. An exemplary content approval workflow process is illustrated in FIG. 2B. As illustrated, when revised web content is checked-in to the ECMS content library 102, a user authorized to approve revised web content for publishing is notified of the revised web content in an operational block 220. In one embodiment, the notification is provided using electronic mail, although other notification techniques can be used in other embodiments. The user authorized to approve revised web content for publishing decides whether to approve the modification in decisional block 222. If the modifications are not approved, processes can be generated in operational block 224, for example to notify the user who revised the content that the revision was not approved.

Referring still to the exemplary workflow illustrated in FIG. 2B, if the modifications to the web content are approved, then the WCM 140 is notified of the revised web content in an operational block 226. One or more workflow processes can then be invoked based on the approved and modified web content. For example, in one embodiment, a website integrity check workflow is optionally invoked, as indicated by operational block 228. The website integrity check monitors the website for broken links or other errors caused by the web content modification. Generally, one of the post-approval workflow processes that is invoked is a publication workflow, indicated by operational block 230, for publishing the modified web content. As described above, the web content can be published on the Internet, or on an intranet residing on a private network. Optionally, additional workflow processes are performed subsequent to publication, such as a user notification workflow to advise website visitors of the revisions to the website.

In addition to workflow processes performed subsequent to web content check-in, workflow processes can also be performed as part of the procedure for checking-out web content from the ECMS content library 102. An exemplary web content check-out workflow process is illustrated in FIG. 2C. As illustrated, a user invokes the workflow by requesting check-out of web content from the ECMS content library 102 in operational block 240. The ECMS 100 determines whether the user is authorized to check-out web content from the ECMS content library 102 in decisional block 242. This determination can optionally be made with reference to the ECMS user authorization content. If the user is not authorized to check-out web content from the ECMS content library 102, context-appropriate procedures, such as notification of a supervisor that unauthorized access was attempted, can be invoked.

Referring still to the exemplary workflow illustrated in FIG. 2C, if the web content check-out is approved, then a copy of the web content, such as a computer file, is checked-out to the authorized user from the ECMS content library 102 in operational block 246. As part of the check-out procedure, certain ECMS functions are optionally disabled in an operational block 248, for example depending on the permissions stored in the ECMS user authorization content. For example, in one embodiment, certain users can have permission to revise web content, but not to delete it from the ECMS content library 102. As another example, in certain embodiments, only specified users will be granted permission to alter web content relationship information. Likewise, as part of the check-out procedure, certain ECMS functions that are unique to WCM data can be enabled, such as an “add to Web” function.

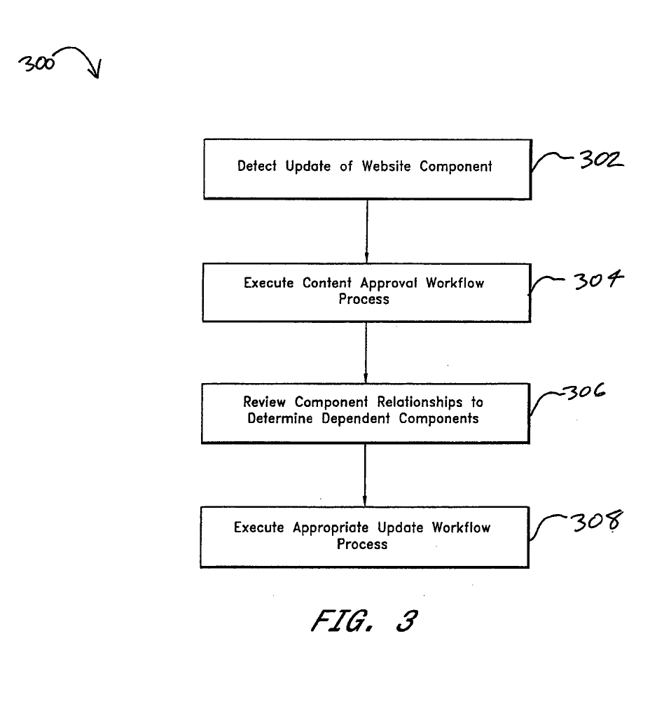

FIG. 3 is a flowchart illustrating an exemplary web content update process 300 that may be employed by the integrated ECMS/WCM system of FIG. 1A. As illustrated, in one embodiment of the process 300, a content approval workflow process and a dependent update workflow process are employed. Advantageously, the workflow process results in the preservation of referential integrity. According to an embodiment, in a block 302 an update of a web site component is detected. In one embodiment, the detection occurs with the aid of the event trigger subsystem. In a block 304, a content approval workflow process is executed on the updated component. In one embodiment, an appropriate content approval workflow process is chosen, based on either the identify of the updated component, its belonging to a particular group of components, some combination of the above, or some other criteria. In a block 306, component relationships are reviewed to determine which, if any, components depend on the updated component.

In a block 308, an appropriate dependent update workflow process is executed. In an embodiment, an optional appropriate workflow process is executed on a particular page component that is dependent on the updated component. Completion of the foregoing workflow processes may be followed by deployment of any web content that successfully passes through the workflow processes. Advantageously, the use of content approval workflow processes such as the foregoing increases web site integrity by ensuring that content passes through an approval process prior to being deployed. Such approval processes increase web site integrity by, for example, allowing one or more participants to detect erroneous content and reject the content or edit the content prior to deployment. Additionally, the use of workflow processes ensures that content follows a defined update procedure as it is propagated throughout a web site, also increasing web site integrity. Additional operations may be performed along with those listed, without fundamentally altering the foregoing method. Examples of additional operations include, but are not limited to, testing a website under load and indexing a website to a search engine.

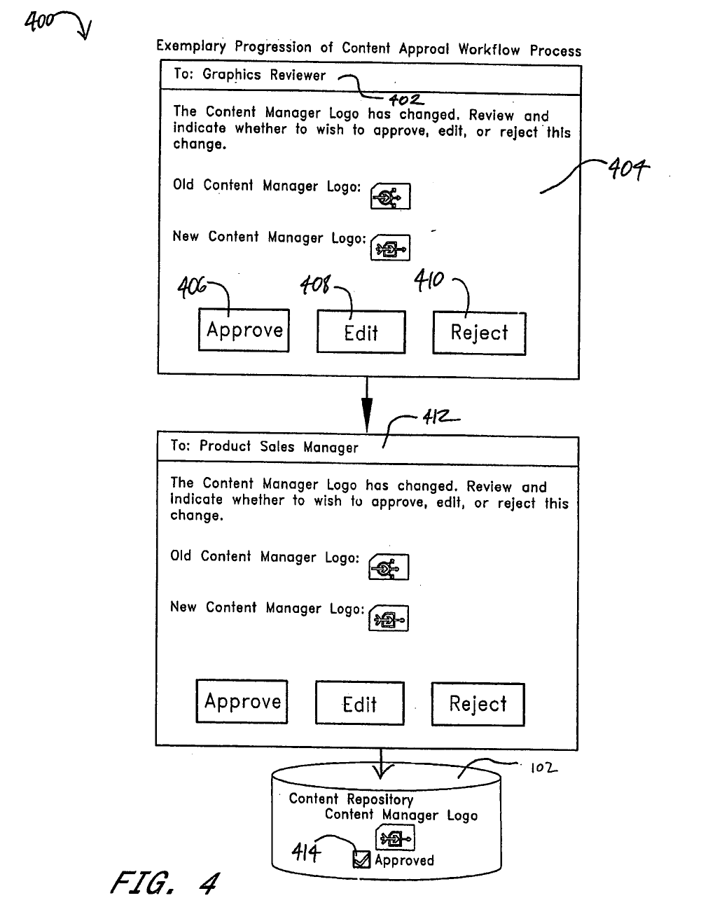

FIG. 4 is a graphical representation of an exemplary progression of a content approval workflow process 400 that may be employed by the integrated ECMS/WCM system of FIG. 1A. In the illustrated example, a content approval workflow process occurs upon an update of a logo. A simplified screen shot 402 illustrates an operation in which a graphics reviewer is presented, in a display area 404, with the updated logo and the older logo and allowed to approve 406, edit 408, or reject 410 the change. A simplified screen shot 412 shows a second operation in which a product sales manager is presented with the same information and with the same options. A depiction of the ECMS content library 102 indicates that the updated logo successfully passed through the approval process and is stored with an indication 414 that the logo has been approved.

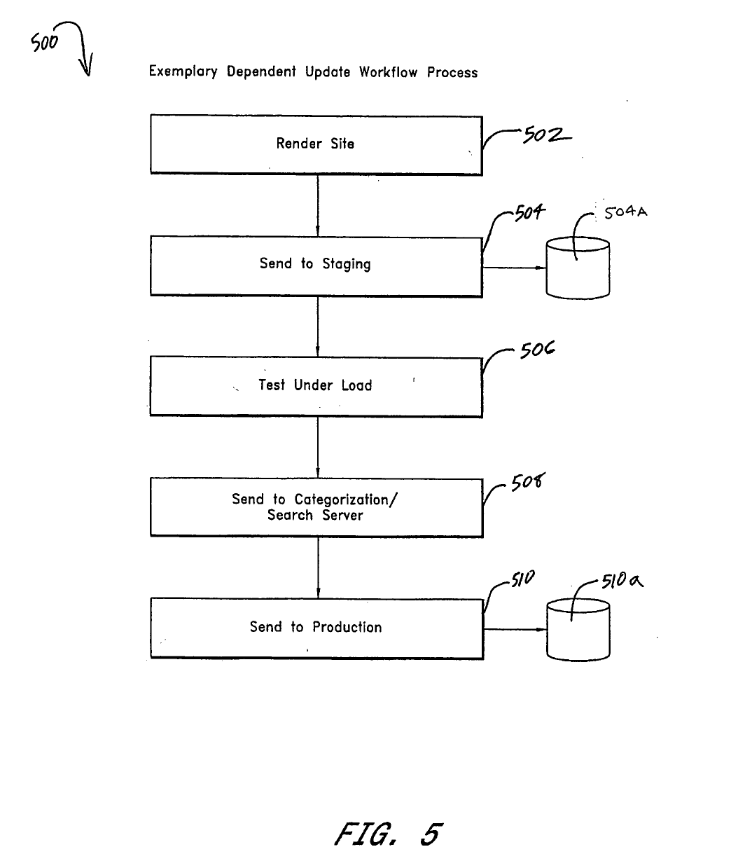

FIG. 5 is a flowchart illustrating an exemplary dependent update workflow process 500 that may be employed by the integrated system of FIG. 1A. In a block 502, some or all of a web site is re-rendered. Re-rendered portions of a web site include, in one embodiment, pages that depend on an updated component that has triggered a dependent update workflow process. In a block 504, the site is sent to a staging server 504a. The staging server 504a is a temporary deployment target at which the site can be tested prior to public deployment. In a block 506, the site may be tested under a load. This testing may be performed using, for example, testing suite applications for subjecting the site to repeated use. Alternatively or in combination, the site may be tested by a number of human testers, such as, for example, beta testers. In a block 508, the site may be sent to a categorization and search server. The categorization and search server may recategorize the content of the site, build a new index for the site, and facilitate, based on the foregoing, searches of the site. In a block 510, the site may be deployed to a production server 510a. In light of the foregoing, a skilled artisan will appreciate that dependent update workflow processes may be used to ensure that a proper procedure is followed during an update of a web page that depends on previously updated components. By using dependent update workflow processes to ensure adherence to such procedure, a developer may avoid web site development errors, such as, for example, a failure to re-render a web page that includes an updated component. In addition to the foregoing operations, a skilled artisan will appreciate, in light of this disclosure, other operations that may be included in a dependent update workflow process, such as, for example, previously listed operations.

### Scope of the Invention

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein can be made without departing from the spirit of the inventions. The accompanying claims and their equivalents are intended to cover such forms or modifications as would fall within the scope and spirit of the inventions.

We claim:

1. A system for managing electronic content on a computer network, the system comprising:
an electronic content library configured to store a plurality of files, and to maintain revision history data for the files stored therein;
a web content manager configured to publish one or more of the files stored in the electronic content library to a website;
a content manager configured to check-out a selected file from the electronic content library upon a user's request, and to check-in an updated version of the selected file to the electronic content library, such that checking-in the updated version of the selected file causes the revision history data in the electronic content library to be updated; and
an event trigger subsystem configured to notify the web content manager of the updated version of the selected file based on a modification to the selected file.

2. The system of claim 1, wherein the event trigger subsystem is further configured to enable selected content manager functions when the selected file is checked-out of the electronic content library.

3. The system of claim 1, wherein the event trigger subsystem is further configured to disable selected content manager functions when the selected file is checked-out of the electronic content library.

4. The system of claim 1, wherein the event trigger subsystem also triggers a web publication related process in the web content manager.

5. The system of claim 1, wherein the event trigger subsystem also triggers an approval subsystem configured to notify a user authorized to approve changes that the updated version of the selected file has been checked-in to the electronic content library.

6. A computerized system for managing electronic content, the system comprising:
an electronic content library configured to store web-based and non-web-based electronic content;
a web content manager configured to perform a web-based activity; and
an event trigger subsystem configured to invoke an event in response to a change to the web-based electronic content stored in the electronic content library, wherein the event triggers the web content manager to perform the web-based activity.

7. The system of claim 6, wherein the web-based activity comprises a dependent update workflow.

8. The system of claim 6, wherein the web-based electronic content comprises computer files containing multimedia data.

9. The system of claim 6, wherein the web-based electronic content comprises computer files containing metadata.

10. The system of claim 6, wherein the web-based electronic content comprises computer files containing text-based documents.

11. The system of claim 6, wherein the electronic content library is further configured to maintain revision history data for the web-based and non-web-based electronic content stored therein.

12. The system of claim 6, wherein the electronic content library is further configured to maintain access control data for the web-based and non-web-based electronic content stored therein.

13. The system of claim 6, wherein the web-based activity comprises publishing web-based electronic content.

14. The system of claim 6, wherein the event trigger subsystem further comprises a listener configured to monitor changes in the web-based electronic content stored in the electronic content library.

15. A computerized system for managing electronic content, the system comprising:
a electronic content library configured to store published and non-published electronic content; and
a first content processor for managing the published and non-published electronic content;
a second content processor for managing the publication of the published electronic content; and
an event trigger subsystem in the first content processor configured to invoke an event in response to a change to the published electronic content stored in the electronic content library, wherein the event triggers a process in the second content processor for performing at least one publication related activity.

16. The system of claim 15, wherein the publication related activity comprises performing a dependent update workflow.

17. The system of claim 15, wherein the first content processor is an enterprise content manager and the second content processor is a web content manager.

18. The system of claim 15, wherein the publication related activity comprises publishing the changed electronic content on an Internet website.

19. The system of claim 15, wherein the publication related activity comprises publishing the changed electronic content on an intranet website.

20. The system of claim 15, wherein the publication related activity comprises publishing the changed electronic content on a website, and checking the integrity of the website.

21. The system of claim 15, wherein the event trigger subsystem further comprises a listener configured to monitor changes in the electronic content stored in the electronic content library.

22. The system of claim 15, wherein the publication related activity comprises a content approval workflow.

23. The system of claim 15, wherein the publication related activity comprises a content approval workflow configured to notify a user authorized to approve changes in the published electronic content.

24. The system of claim 15, wherein the publication related activity comprises publishing the changed electronic content and notifying a workgroup of changes in the published electronic content.

25. A computerized system for managing electronic content, the system comprising:
a content manager configured to store electronic content;
a web content manager configured to perform a workflow process on electronic content, wherein the workflow process is a web-based activity; and
an event trigger subsystem configured to invoke the workflow process in response to a modification of the electronic content stored in the content manager.

26. The system of claim 25, wherein the workflow process comprises deploying the modified electronic content to a website.

27. The system of claim 25, wherein the workflow process comprises making dependent updates to a website based on the modified electronic content.

28. The system of claim 25, wherein the electronic content comprises computer files containing multimedia data.

29. The system of claim 25, wherein the electronic content comprises computer files containing metadata.

30. The system of claim 25, wherein the electronic content comprises computer files containing text-based documents.

31. The system of claim 25, wherein the content manager is further configured to maintain revision history data for the electronic content stored therein.

32. The system of claim 25, wherein the content manager is further configured to maintain access control data for the electronic content stored therein.

33. A system for managing electronic content, the system comprising:
a first means for storing electronic content; and
a second means for invoking a web-based workflow process in response to a modification of the electronic content stored in the content manager.

34. The system of claim 33, wherein the web-based workflow process comprises deploying the modified electronic content to a website.

35. The system of claim 33, wherein the web-based workflow process comprises making dependent updates to a website based on the modified electronic content.

36. A method for managing electronic content on a computer network, the method comprising:
storing a plurality of files in an electronic content library;
maintaining revision history data for at least one of the files stored in the electronic content library;
publishing one or more of the files stored in the electronic content library using a web content manager;
checking-out a selected file from the electronic content library upon a user's request;
checking-in an updated version of the selected file to the electronic content library;
updating the revision history data in the electronic content library in response to the updated version of the selected file being checked-in; and
notifying the web content manager of the updated version of the selected file based on a modification to the selected file.

37. The method of claim 36, wherein the one or more files stored in the electronic content library is published after the web content manager is notified of the updated version of the selected file.

38. The method of claim 36, wherein notifying the web content manager of the updated version of the selected file triggers a web publication related process in the web content manager.

39. The method of claim 36, further comprising notifying a user authorized to approve changes that the updated version of the selected file has been checked-in to the electronic content library.

40. A method for managing electronic content, the method comprising:
storing web-based and non-web-based electronic content in an electronic content library; and
invoking an event in response to a change to the web-based electronic content stored in the electronic content library, wherein the event triggers a web content manager to perform at least one web-based activity.

41. The method of claim 40, wherein the web-based electronic content comprises computer files containing multimedia data.

42. The method of claim 40, wherein the web-based electronic content comprises computer files containing metadata.

43. The method of claim 40, wherein the web-based electronic content comprises computer files containing text-based documents.

44. The method of claim 40, further comprising maintaining revision history data in the electronic content library for the web-based and non-web-based electronic content stored therein.

45. The method of claim 40, further comprising maintaining access control data in the electronic content library for the web-based and non-web-based electronic content stored therein.

46. The method of claim 40, wherein the web-based activity comprises publishing web-based electronic content.

47. The method of claim 40, wherein the web-based activity comprises performing a dependent update workflow.

48. The method of claim 40, further comprising monitoring changes in the web-based electronic content stored in the electronic content library using a listener.

49. A method for managing electronic content, the method comprising:
storing published and non-published electronic content in an electronic content library;
managing the published and non-published electronic content in a first content processor;
managing the publication of the published electronic content in a second content processor; and
invoking an event in response to a change to the published electronic content stored in the electronic content library, wherein the event triggers a process in the second content processor for performing at least one publication related activity.

50. The system of claim 49, wherein the publication related activity comprises performing a dependent update workflow.

51. The method of claim 49, wherein the first content processor is an enterprise content manager and the second content processor is a web content manager.

52. The method of claim 49, further comprising publishing the changed electronic content on an Internet website.

53. The method of claim 49, further comprising publishing the changed electronic content on an intranet website.

54. The method of claim 49, further comprising:
publishing the changed electronic content on a website; and
checking the functional integrity of the website.

55. The method of claim 49, further comprising monitoring for changes made to the electronic content stored in the electronic content library.

56. The method of claim 49, further comprising executing a content approval workflow.
